(19) United States
(12) Patent Application Publication
(10) Pub. No.: US 2003/0091327 A1
(43) Pub. Date: May 15, 2003

(54) Monitor recording and reproducing device

(75) Inventors: Seiji Hashimoto, Osaka (JP); Michihiro Fujiyama, Kyoto (JP)

Correspondence Address: ARMSTRONG,WESTERMAN & HATTORI, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/293,343

(22) Filed: Nov. 14, 2002

(30) Foreign Application Priority Data
Nov. 14, 2001 (JP) 348921/2001

(51) Int. Cl. H04N 5/91

(52) U.S. Cl. 386/46

(57) ABSTRACT

Processing for successively writing video data for normal recording into a normal recording area is performed, and video data for alarm recording is repeatedly overwritten on a predetermined area in an alarm recording area. The video data for alarm recording after generating an alarm signal is written into the alarm recording area. The video data for normal recording after stopping the alarm signal is written from a portion of the normal recording area where the video data for normal recording corresponding to the video data for alarm recording recorded on the predetermined area is recorded.

### BACKGROUND OF THE INVENTION

### FIELD OF THE INVENTION

The present invention relates to a monitor recording and reproducing device that performs monitor recording and reproduction using a hard disk drive, for example.

A recording and reproducing device that is of a head moving type and can access all data randomly, for example, a hard disk drive (HDD) is used as a monitor recording and reproducing device. Examples of the recording of monitored video data include normal recording making it possible to perform long-time recording by increasing a compression rate or reducing a frame rate and alarm recording performed by reducing a compression rate or increasing a frame rate. When an alarm signal is generated during the normal recording, such control that the normal recording is switched to the alarm recording is carried out. As a method of the recording control by switching, a method of performing normal recording and alarm recording in time series (sequentially) without dividing a recording area into a normal recording area and an alarm recording area has been generally used. On the other hand, it is considered that such control as to divide a recording area into a normal recording area and an alarm recording area, to repeatedly overwrite a newest video portion by alarm recording using the alarm recording area during the normal recording (pre-alarm recording) as well as to perform the alarm recording in the alarm recording area when an alarm signal is raised, while switching the alarm recording to normal recording in the normal recording area when the alarm signal is stopped is carried out.

In reproduction in a case where the former recording control is employed, however, monitored video can be simply reproduced in time series, while video cannot be reproduced at a low compression rate or a high frame rate immediately before the alarm because it is not recorded by the alarm recording. On the other hand, in reproduction in a case where the latter recording control is carried out, video can be reproduced by the pre-alarm recording at a low compression rate or a high frame rate immediately before the alarm. When the reproduction for the normal recording area is performed, however, an operator performs an operation for the reproduction. On the other hand, when the reproduction for the alarm recording area is performed, an operator performs an operation for the reproduction. Since the operations of the reproduction for both the areas are thus separately performed, the reproduction for the normal recording and the reproduction for the alarm recording cannot be continuously performed so as to correspond to the time axis of monitor imaging.

### SUMMARY OF THE INVENTION

In view of the foregoing circumstances, an object of the present invention is to provide a monitor recording and reproducing device making it possible to perform pre-alarm recording by dividing a recording area into a normal recording area and an alarm recording area and making it possible to eliminate overlapped video recording as well as capable of continuously performing reproduction for normal recording and reproduction for alarm recording so as to correspond to the time axis of monitor imaging.

In order to solve the above-mentioned problem, in a monitor recording and reproducing device in which a normal recording area and an alarm recording area are assigned to a recording medium, a monitor recording and reproducing device according to the present invention is characterized by comprising writing control means for carrying out such first control as to perform processing for successively writing video data for normal recording into the normal recording area and repeatedly overwriting video data for alarm recording on a predetermined area in the alarm recording area, such second control as to write the video data for alarm recording after generating an alarm signal into the alarm recording area, and such third control as to write the video data for normal recording after stopping the alarm signal from a portion of the normal recording area where the video data for normal recording corresponding to the video data for alarm recording recorded on the predetermined area is recorded.

In the above-mentioned configuration, the recording area is divided into the normal recording area and the alarm recording area, thereby making it possible to perform pre-alarm recording and making it possible to eliminate overlapped video recording as well as capable of continuously performing reproduction for the normal recording and reproduction for the alarm recording so as to correspond to the time axis of monitor imaging.

The writing control means may be so configured as to suitably add an address to be a destination of transition to the alarm recording area in a case where the video data for normal recording is recorded, while suitably adding an address to be a destination of transition to the normal recording area in a case where the video data for alarm recording is recorded.

Reproduction in the alarm recording area may be performed when the address to be a destination of transition to the alarm recording area is obtained in a state where the video data for normal recording is reproduced, while reproduction in the normal recording area may be performed when the address to be a destination of transition to the normal recording area is obtained in a state where the video data for alarm recording is reproduced.

Consequently, the reproduction for the normal recording and the reproduction for the alarm recording can be continuously and smoothly performed so as to correspond to the time axis of the monitor imaging.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a monitor recording and reproducing device according to an embodiment of the present invention;

FIGS. 2 (a) and 2 (b) are diagrams for explaining recording of input video data on a normal recording area and recording thereof on an alarm recording area; and

FIGS. 3 (a) to 3 (b) are diagrams for explaining the transition between recording on a normal recording area and recording on an alarm recording area.

### DESCRIPTION OF THE PREFERRED EMBODIMENTS

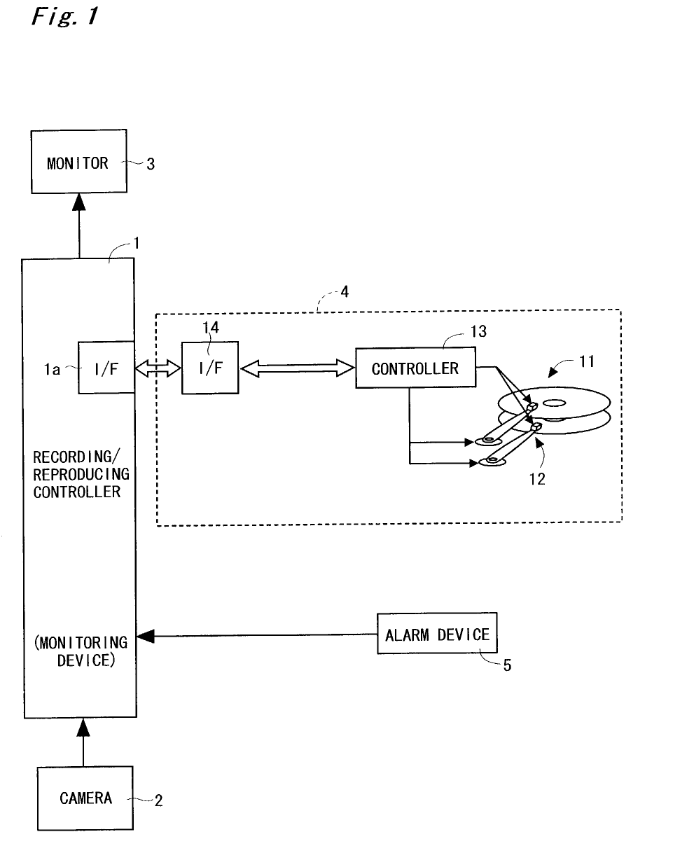

A monitor recording and reproducing device according to an embodiment of the present invention will be described on the basis of FIGS. 1 to 3.

In the monitor recording and reproducing device according to the present embodiment, by control of a recording and reproducing controller 1, input video data from a camera 2 is written into (recorded on) a recorder 4, and the input video data and video data read out of the recorder 4 are fed (reproduced) to a monitor 3, as shown in FIG. 1.

The recorder 4 is a hard disk drive (HDD) comprising a magnetic head 12 for writing/reading information to/from a magnetic disk 11. A controller 13 carries out control for recording/reproducing in accordance with a command from the recording and reproducing controller 1, and carries out control (seek) for moving the magnetic head 12 to a predetermined track on the magnetic disk 11, control for modulating/demodulating information in order to write and read out the information on the predetermined track, and so forth. Information is exchanged between the recorder 4 and the recording and reproducing controller 1 through an interface 14 in the recorder 4 and an interface 1a provided in the recording and reproducing controller 1.

An alarm device 5 generates an alarm signal to feed the alarm signal to the recording and reproducing controller 1 in a case such as a case where an emergency button is pressed or a case where an invader is sensed by an invader sensor, for example.

The recording and reproducing controller 1 manages a recording area of the magnetic disk 11, to record video data from the camera 2 on a normal recording area of the magnetic disk 11 when the alarm device 5 generates no alarm signal, and moves the magnetic head 12 to an alarm recording area, to also repeatedly record the video data on a pre-alarm recording area in the alarm recording area. On the other hand, when the alarm device 5 generates the alarm signal, the video data from the camera 2 is recorded on the alarm recording area of the magnetic disk 11. At the time of reproduction, a command is issued to the recorder 4 such that the magnetic head 12 is suitably moved between the normal recording area and the alarm recording area in order to reproduce the video from the magnetic disk 11 so as to correspond to the time axis of imaged video.

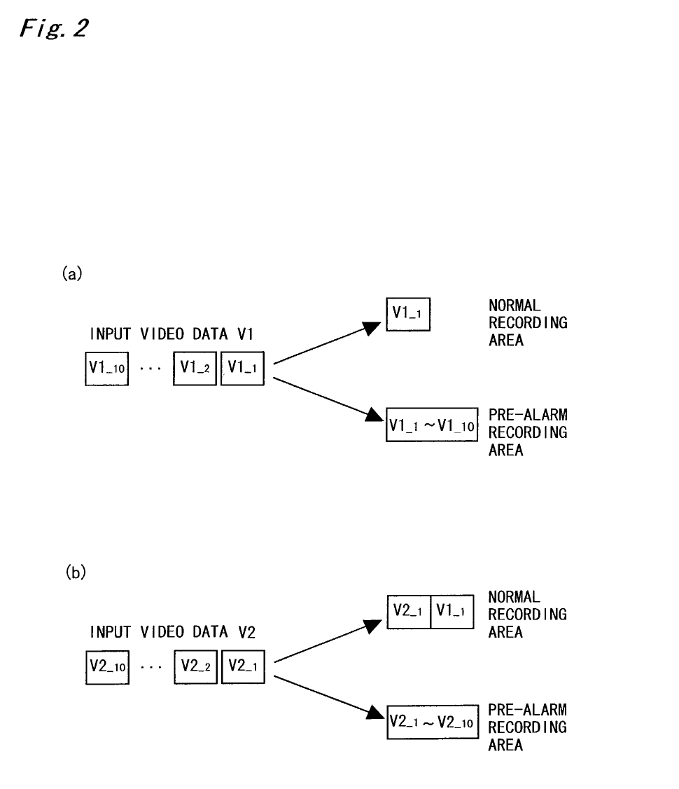

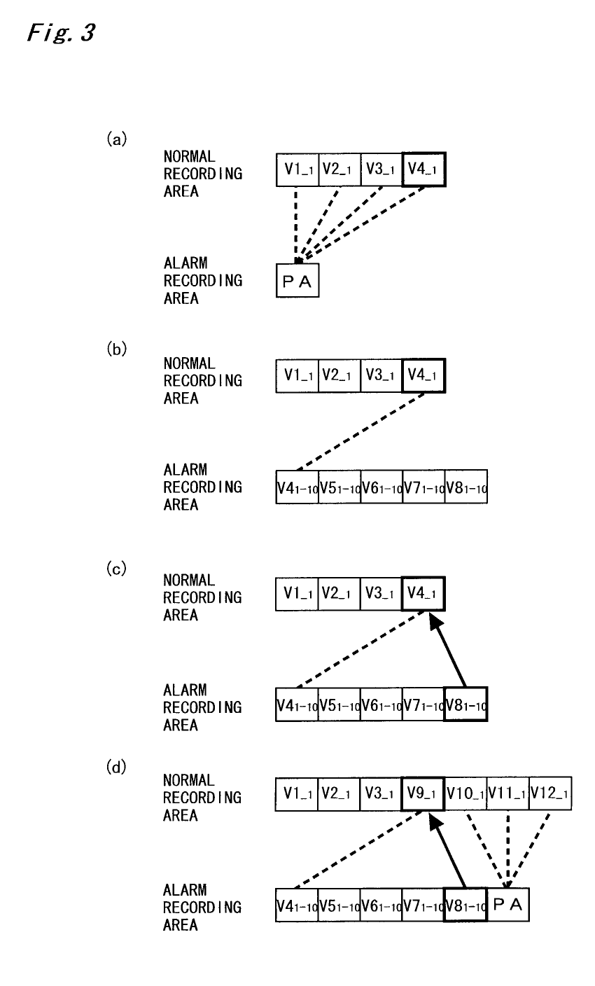

The above-mentioned recording/reproducing processing will be specifically described using FIGS. 2 and 3. As an example, it is assumed that input video data V1 at a time which is fed from the camera 2 is data corresponding to ten frames, i.e., V1_1 to V1_10, the data V1_1 out of the data corresponding to ten frames is recorded on the normal recording area, and the data V1_1 to V1_10 are recorded on the pre-alarm recording area, as shown in FIG. 2 (a). It is assumed that input video data V2 at the next time is data corresponding to ten frames, i.e., V2_1 to V2_10, the data V2_1 is recorded on the normal recording area subsequently to a portion where the data V1_1 is recorded, and the data V2_1 to V2_10 which are newest videos are overwritten on the pre-alarm recording area, as shown in FIG. 2 (b). Such processing is continued until an alarm signal is generated.

FIG. 3 (a) illustrates a state where data V1_1, V2_1, V3_1, and V4_1 in input video data V1, V2, V3, and V4 are successively recorded on the normal recording area, and a state where data corresponding to ten frames in each of the input video data V1, V2, V3, and V4 at times are repeatedly overwritten on a pre-alarm recording area PA in the alarm recording area. It is assumed that an alarm signal is generated when the input video data V4 is being fed.

When an alarm signal is generated in a case where the input video data V4 is being fed, the data corresponding to ten frames in the input video data V4 remain without being overwritten in the pre-alarm recording area PA, as shown in FIG. 3 (b). Data corresponding to ten frames in each of input video data V5, V6, V7, and V8 (post-alarms) are recorded on the alarm recording area subsequent to the pre-alarm recording area PA.

When the alarm signal is stopped in a case where the input video data V8 is being fed, the subsequent input video data are recorded on the normal recording area, as shown in FIG. 3 (c). At this time, data V9_1 in the subsequent input video data V9 is recorded on a portion where the video data V4_1 at the same time as the video data V4_1 to V4_10 recorded on the pre-alarm recording area PA is recorded. Since the video data V4_1 is recorded on the pre-alarm recording area PA, overlapped recording of the same video can be eliminated.

Consequently, the data V9_1 in the input video data V9 is recorded subsequently to a portion where the input video data V3_1 is recorded in the normal recording area, and data V10_1, V11_1, and V12_1 each corresponding to one frame in the subsequent input video data V10, V11, and V12 are then successively recorded subsequently to a portion where the data V9_1 is recorded on the normal recording area, as shown in FIG. 3 (d). Data corresponding to ten frames in each of the input video data V10, V11, and V12 at times are repeatedly overwritten on a new pre-alarm recording area PA in the alarm recording area.

An example of reproduction processing will be then described. Assuming herein that a video number is assigned to each of the video data, as shown in FIG. 3, at the time of recording, for example, when control is carried out such that the video data are reproduced in the order of their video numbers, the data V1_1, V2_1, and V3_1 are reproduced in the order of their video numbers at the time of reproduction for the normal recording area. Thereafter, the video number is V9_1. Accordingly, it can be judged in the recording and reproducing controller 1 that there is no continuity. Therefore, the recording and reproducing controller 1 issues a command to the recorder 4, to move the magnetic head 12 to the alarm recording area to search for the video data whose video number is V4_1.

If the video data whose video number is V4_1 is found, the video data in the recording areas subsequent thereto are reproduced, thereby reproducing the data V4_1 to V4_10, V5_1 to V5_10, V6_1 to V6_10, V7_1 to V7_10, and V8_1 to V8_10 in the order of their video numbers. Thereafter, the video number is not V9_1. Accordingly, it can be judged in the recording and reproducing controller 1 that there is no continuity. Therefore, the recording and reproducing controller 1 issues a command to the recorder 4, to move the magnetic head 12 to the normal recording area to search for the video data whose video number is V9_1.

If the video data whose video number is V9_1 is found, the video data in the recording areas subsequent thereto are reproduced, thereby reproducing the data V9_1, V10_1, V11_1, and V12_1 in the order of their video numbers.

The video data is recorded by being assigned an address, as indicated by the following Table, so that the reproduction can smoothly correspond to the time axis of monitor imaging:

TABLE 1

| | added address | added address | added address |
|---|---|---|---|
| | information 1 | Information 2 | information 3 |
| pre-alarm | normal | prior post | posterior post |
| | recording | last address \mathring{2} | head address \mathring{3} |
| | address \mathring{1} | | |
| post-alarm | pre-alarm | normal start | pre-alarm |
| | start address \mathring{4} | address \mathring{5} | newest address \mathring{6} |
| normal REC | post last | pre-alarm | |
| | address \mathring{7} | start address \mathring{8} | |

By adding a pre-alarm recording start address (an address at which the recording of the data V4_1 is started) \mathring{8} in recording the data V9_1, when a readout portion of the recording area enters the data V9_1 at the time of reproduction, the position where the recording of the data V4_1 is started in the pre-alarm recording area can be known by the pre-alarm recording start address \mathring{8}. Thereafter, the processing can smoothly proceed to reproduction of data in the pre-alarm recording area. By adding a posterior post head address \mathring{3} in pre-alarm recording, the processing can smoothly proceed to reproduction of the data V5_1 and the subsequent data. A normal start address (an address at which the recording of the data V9_1 is started) \mathring{5} is added to the data V8_10. Therefore, the processing can smoothly proceed to reproduction of data in the normal recording area.

At the time of inverse reproduction, when the data V9_1 is reproduced, the position where the recording of the data V8_10 is started is known by a post last address (an address at which the recording of the data V8_10 is started) \mathring{7}. Thereafter, the processing can smoothly proceed to reproduction of data in the alarm recording area. By adding an address at which the recording of the data V3_1 is started as a normal recording address \mathring{1} in recording the data V4_1 in the pre-alarm recording area, the position where the recording of the data V3_1 is started is known by the normal recording address (an address at which the recording of the data V3_1 is started) \mathring{1} when the data V4_1 is reproduced at the time of inverse reproduction. Therefore, the processing can smoothly proceed to reproduction of data in the normal recording area.

The continuous reproduction of only the alarm recording area, for example, is also possible by various types of added addresses.

Although in the above-mentioned example, the normal recording is constructed as recording of one of ten frames, and the alarm recording and the pre-alarm recording are constructed as recording of a total of ten frames, the present invention is not limited to the same. The difference between the normal recording and the alarm recording (pre-alarm recording) is not limited to the difference in frame rates. For example, there may be a difference in image compression rates between the normal recording and the alarm recording. Although both the alarm recording and the pre-alarm recording are constructed as recording of ten frames, there may be a slight difference between the alarm recording and the pre-alarm recording. Further, the recording medium is not limited to a magnetic disk. Another recording medium such as a magneto-optical disk may be also used.

As described in the foregoing, according to the present invention, the recording area is divided into the normal recording area and the alarm recording area, thereby making it possible to perform the pre-alarm recording and making it possible to eliminate overlapped video recording as well as capable of continuously performing the reproduction for the normal recording and the reproduction for the alarm recording so as to correspond to the time axis of monitor imaging. Further, if the monitor recording and reproducing device is so configured that a predetermined address is added in the case of recording, the continuous reproduction can be smoothly performed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. In a monitor recording and reproducing device in which a normal recording area and an alarm recording area are assigned to a recording medium, the monitor recording and reproducing device comprising
writing control means for carrying out such first control as to perform processing for successively writing video data for normal recording into the normal recording area and repeatedly overwriting video data for alarm recording on a predetermined area in the alarm recording area, such second control as to write the video data for alarm recording after generating an alarm signal into the alarm recording area, and such third control as to write the video data for normal recording after stopping the alarm signal from a portion of the normal recording area where the video data for normal recording corresponding to the video data for alarm recording recorded on said predetermined area is recorded.

2. The monitor recording and reproducing device according to claim 1, wherein
said writing control means suitably adds an address to be a destination of transition to the alarm recording area in a case where the video data for normal recording is recorded, while suitably adding an address to be a destination of transition to the normal recording area in a case where the video data for alarm recording is recorded.

3. The monitor recording and reproducing device according to claim 2, wherein
reproduction in the alarm recording area is performed when the address to be a destination of transition to the alarm recording area is obtained in a state where the video data for normal recording is reproduced, while reproduction in the normal recording area is performed when the address to be a destination of transition to the normal recording area is obtained in a state where the video data for alarm recording is reproduced.
